(19) United States
(12) Patent Application Publication
(10) Pub. No.: US 2025/0279937 A1
(43) Pub. Date: Sep. 4, 2025

(54) DYNAMIC TRAFFIC MIRRORING OF AUTOMOTIVE ETHERNET TRAFFIC ACROSS A NETWORK TOPOLOGY

(71) Applicant: GM GLOBAL TECHNOLOGY OPERATIONS LLC, Detroit, MI (US)

(72) Inventors: Sudhakaran Maydiga, Troy, MI (US); Chang Liu, Ann Arbor, MI (US); Subhash V. Doddachikkaveeranna, Troy, MI (US)

(73) Assignee: GM GLOBAL TECHNOLOGY OPERATIONS LLC, Detroit, MI (US)

(21) Appl. No.: 18/592,869

(22) Filed: Mar. 1, 2024

(51) Int. Cl. H04L 41/12; H04L 43/12; H04L 45/12

(52) U.S. Cl. CPC H04L 41/12; H04L 43/12; H04L 45/123

(57) ABSTRACT

Herein, a technology that facilitates dynamic traffic monitoring of automotive Ethernet traffic across a network topology is discussed. The technology includes a facilitator node receiving via an automotive Ethernet network a traffic-mirroring request from a requester node and based on that code, the facilitator node determines a source port and a source switch of the source node. The technology also includes the facilitator node determining a traffic-mirroring network path between the source node and the requester node based on an obtained network topology matrix. The technology also includes the facilitator node initiating mirroring of the network traffic of the source node by sending traffic-mirroring instructions to the switches in the determined traffic-mirroring network path that instructs such switches to mirror network traffic of the source port to the request node.

### INTRODUCTION

Automotive Ethernet networking technology refers to the use of Ethernet communication in vehicles to interconnect various electronic components and systems. It serves as the in-vehicle network that provides high-speed data communication between sensors, electronic control units (ECUs), infotainment systems, advanced driver assistance systems (ADAS), etc. Common automotive Ethernet variants used are 100BASE-T1 and 1000BASE-T1 that provide 100 Mbps and 1 Gbps speeds respectively over unshielded single twisted pair cables. Automotive Ethernet unifies in-vehicle connectivity, providing high bandwidth, real-time capabilities, security, and diagnostic features for next-gen vehicles with growing electronics and software.

### SUMMARY

According to one implementation, a method that facilitates dynamic traffic monitoring of automotive Ethernet traffic across a network topology, the method includes receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches; based on the source-node associated code, determining a source port and a source switch through which the source node directly links to the automotive Ethernet network; obtaining a network topology matrix, which specifies one or more ports of each switch that connects to at least one of the other multiple interconnected switches of the network topology; based on the network topology matrix, determining a traffic-mirroring network path between the source node and the requester node; and initiating mirroring of the network traffic of the source node by sending, by the facilitator node via the automotive Ethernet network, traffic-mirroring instructions to the switches in the determined traffic-mirroring network path that instruct such switches to mirror network traffic of the source port to the request node.

In this implementation, wherein the requester node connects to a requester port of a requester switch of the multiple interconnected switches of the network topology and the request from the requester node is associated with an identification of the requester port and the requester switch.

In this implementation, wherein the source-node associated code that is selected from a group consisting of an indicator of the source node, an indicator of the source port and source switch of the source node, an automotive diagnostic code that is indicative of the source node, and a combination thereof.

In this implementation, wherein the determination of the source port and source switch includes: obtaining a table of node-associated codes; finding an entry in the table that matches the received code; extracting an identification of a switch and one of its ports from the entry; and assigning the identified switch and port as the source port and the source switch through which the source node directly links to the automotive Ethernet network.

In this implementation, wherein each entry in the network topology matrix specifies which one or more ports of a switch are directly connected to which one or more ports of directly connected switches of the multiple interconnected switches of the network topology.

This implementation further includes detecting, by the facilitator node, a change to the network topology; and updating the network topology matrix accordingly.

In this implementation, wherein the determining of the traffic-mirroring network path includes: calculating an optimal network path between the source node and the requester node; and assigning the calculated optimal network path to the traffic-mirroring network path.

In such an implementation, wherein the calculation of the optimal network path employs zero weighting to determine a shortest path.

In such an implementation, wherein the calculation of the optimal network path employs weighting to determine a shortest path.

In such an implementation, wherein the weighting is based upon a determination of functional traffic on each port and/or switch in a network path.

In such an implementation, wherein the facilitator node tracks the functional traffic on each port and/or switch of the network topology.

In this implementation, wherein the traffic-mirroring instructions directly command the switches in the determined traffic-mirroring network path to mirror network traffic of the source port to the request node.

In this implementation, wherein the traffic-mirroring instructions requests that the switches in the determined traffic-mirroring network path cooperate in mirroring network traffic of the source port to the request node.

According to another implementation, a method that facilitates dynamic traffic monitoring of automotive Ethernet traffic across a network topology, the method includes: receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches; based on the source-node associated code, determining a source port and a source switch through which the source node directly links to the automotive Ethernet network; obtaining a network topology matrix, wherein each entry in the network topology matrix specifies which one or more ports of a switch are directly connected to which one or more ports of directly connected switches of the multiple interconnected switches of the network topology; based on the network topology matrix, determining a traffic-mirroring network path between the source node and the requester node, wherein the determining of the traffic-mirroring network path includes calculating an optimal network path between the source node and the requester node; and assigning the calculated optimal network path to the traffic-mirroring network path; and initiating mirroring of the network traffic of the source node by sending, by the facilitator node via the automotive Ethernet network, traffic-mirroring instructions to the switches in the determined traffic-mirroring network path that instruct such switches to mirror network traffic of the source port to the request node.

In this implementation, wherein the source-node associated code that is selected from a group consisting of an indicator of the source node, an indicator of the source port and source switch of the source node, an automotive diagnostic code that is indicative of the source node, and a combination thereof.

In this implementation, wherein the determination of the source port and source switch includes: obtaining a table of node-associated codes; finding an entry in the table that matches the received code; extracting an identification of a switch and one of its ports from the entry; assigning the identified switch and port as the source port and the source switch through which the source node directly links to the automotive Ethernet network.

In this implementation, wherein the calculation of the optimal network path employs weighting to determine a shortest path and the weighting is based upon a determination of functional traffic on each port and/or switch in a network path.

According to still another implementation, a non-transitory machine-readable storage medium encoded with instructions executable by one or more processors that, when executed, direct one or more processors to perform operations that facilitates dynamic traffic monitoring of automotive Ethernet traffic across a network topology, the operations comprising: receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches; based on the source-node associated code, determining a source port and a source switch through which the source node directly links to the automotive Ethernet network; obtaining a network topology matrix, wherein each entry in the network topology matrix specifies which one or more ports of a switch are directly connected to which one or more ports of directly connected switches of the multiple interconnected switches of the network topology; based on the network topology matrix, determining a traffic-mirroring network path between the source node and the requester node, wherein the determining of the traffic-mirroring network path includes calculating an optimal network path between the source node and the requester node; and assigning the calculated optimal network path to the traffic-mirroring network path; and initiating mirroring of the network traffic of the source node by sending, by the facilitator node via the automotive Ethernet network, traffic-mirroring instructions to the switches in the determined traffic-mirroring network path that instruct such switches to mirror network traffic of the source port to the request node.

In this implementation, wherein the source-node associated code that is selected from a group consisting of an indicator of the source node, an indicator of the source port and source switch of the source node, an automotive diagnostic code that is indicative of the source node, and a combination thereof.

In this implementation, wherein the calculation of the optimal network path employs weighting to determine a shortest path and the weighting is based upon a determination of functional traffic on each port and/or switch in a network path.

### BRIEF DESCRIPTION OF THE DRAWINGS

FIG. 1 illustrates an example vehicle with an in-vehicle network in accordance with one or more implementations described herein.

FIG. 2 illustrates an example of computer architecture for a computing system capable of executing the technology described herein.

FIG. 3 is a flowchart illustrating a process to perform an example method that facilitates dynamic traffic monitoring of automotive Ethernet traffic across a network topology, in accordance with one or more implementations described herein.

### DETAILED DESCRIPTION

The technology described herein facilitates dynamic traffic monitoring of automotive Ethernet traffic across a network topology. For example, without prior knowledge of the network topology of an automotive Ethernet network of an automobile, an automotive diagnostic tool may be plugged into an available port of the network. By supplying an automotive diagnostic routine control code, with the technology described herein, the automotive diagnostic tool monitors the network traffic flowing to and from a network-connected system that is implicated by the supplied automotive diagnostic routine control code.

Referring now to the drawings, wherein like numerals indicate like parts in the several views of various systems and approaches are shown and described herein. Disclosed approaches may be suitable for use with automotive vehicles, which include manual, autonomous, and semi-autonomous driving.

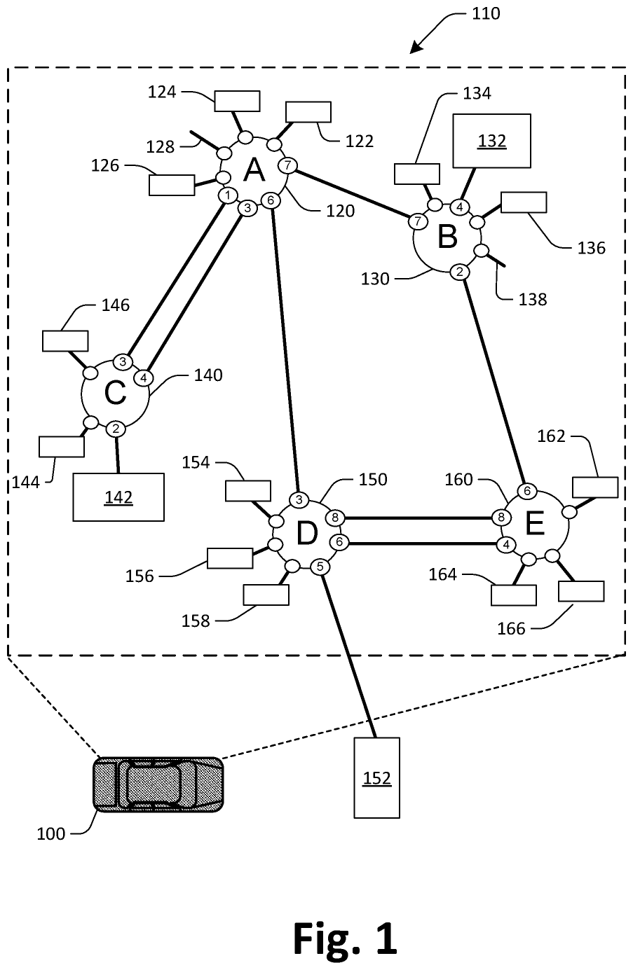

FIG. 1 illustrates an example vehicle 100 suitable to employ one or more implementations of the technology described herein. This figure illustrates an in-vehicle network 110 that employs automotive Ethernet technology to internally connect automotive devices and systems. An automotive Ethernet network includes a set of interconnected nodes (e.g., electronic control units (ECUs)) that are linked to the network via automotive switches.

In an automotive Ethernet network, a switch refers to an Ethernet switch that is designed to provide connectivity and packet switching capabilities within an in-vehicle network. Automotive Ethernet switches allow different ECUs and devices in the vehicle to interconnect and communicate over Ethernet networks. Automotive Ethernet switches provide fast switching fabrics to move data with low predictable latency for time-critical traffic. Examples of vendors of Automotive Ethernet switches include Broadcom, Marvell, Microchip, Renesas, and TTTech.

In an automotive Ethernet network, a node refers to a device or endpoint connected to an in-vehicle Ethernet network for data communication purposes. A node refers to an addressable device with a network interface that is connected into the common automotive architecture for data exchange and control capabilities. The nodes communicate over the switched Ethernet fabric as part of the integrated electrical-electronic system.

In an automotive Ethernet network, a node may be, for example, an ECU, sensor, actuator, user-interface, gateway, or the like. ECUs are embedded computers that control various subsystems in the vehicle through the network such as engine, transmission, audio/visual (AV) displays. Sensors are devices that gather vehicle condition data or environmental data. Examples of such sensors include cameras, RADAR (i.e., radio detection and range), ultrasonics, and temperature sensors. Actuators are output devices that receive control signals over the network to operate vehicle mechanisms. Examples of actuators include motors, pumps, compressors, relays, or lights. Examples of user interfaces include dashboard displays, infotainment head units, and the like. The user interface provides user interaction capabilities. Gateways are hardware devices that translate between Ethernet and other in-vehicle buses like CAN (Controller Area Network) or LIN (Local Interconnect Network) to allow interoperation between legacy and new interfaces.

An automotive Ethernet network includes multiple interconnected switches. Each switch has multiple ports available for directly connecting to nodes or other switches. The nodes connect to an automotive Ethernet network by connecting to the available port of a switch of such a network. The switches form a network by directly connecting another switch to one or more of their ports. Herein, unless the context indicates otherwise, a direct connection or link is a wired or wireless network connection without an intermediary node or port therebetween. Furthermore, a directly wired connection or link excludes a wireless network connection of the above-described direct connection or link.

In one or more implementations described herein, the Ethernet switches and one or more of the nodes are attached to switch ports using xMII interfaces without physical transceivers, hence prevents tapping devices between the node and switch port. This presents a substantial challenge to monitoring Ethernet traffic for a specific node, particularly if the node resides within an internal network subnet and lacks direct accessibility from external connectors like a DLC. The data link connector (DLC) is the multi-pin diagnostic connection port for automobiles, trucks, and motorcycles used to interface a scan tool with the control modules of a given vehicle and access on-board diagnostics and live data streams.

“xMII” refers to Media Independent Interface such as RMII, RGMII, SMII, etc. that support 100 Mbps (Megabits per second) or multi-Gbps (Gigabits per second) speeds for in-vehicle networking. This includes, specifically, 100BASE-T1 and 1000BASE-T1. 100BASE-T1 provides 100 Mbps Ethernet connectivity over a single unshielded twisted pair (UTP) cable. Optimized for automotive use with features like reduced EMI (electromagnetic interference) susceptibility. Used in many modern vehicles. For example, 1000BASE-T1 provides 1 Gbps Ethernet connectivity over a single UTP cable. Emerging in new vehicle designs that utilize higher bandwidth for applications like cameras, RADAR, infotainment, etc.

As depicted in FIG. 1, the in-vehicle network 110 of vehicle 100 has five interconnected switches: switch A 120, switch B 130, switch C 140, switch D 150, and switch E 160. The ports of the switches are indicated by an encircled single digit number from one to eight. As depicted, the switches of the in-vehicle network 110 are interconnected in this manner:
Port 7 of switch A 120 is connected to port 7 of switch B 130;
Ports 1 and 3 of switch A 120 are connected to ports 3 and 4, respectively, of switch C 140;
Port 2 of switch B 130 is connected to port 6 of switch E 160;
Port 6 of switch A 120 is connected to port 3 of switch D 150; and.
Ports 8 and 6 of switch D 150 are connected to ports 8 and 4, respectively, of switch E 160.

As depicted, the switches have multiple nodes connected via a port to a switch. Some switches may have nodes attached to unlabeled ports. This is depicted as an empty circle over a line between a switch and a node. Some switches may have open ports, which is a port without a node connected thereto. This is depicted by a line emanating from a switch without a node connected thereto.

Switch A 120 has node 122, node 124, and node 126 connected thereto via an unlabeled port. Switch A 120 also has an open port 128.

Switch B 130 has a facilitator node 132 connected via port 4 and nodes 134 and 136 connected thereto via unlabeled ports. Switch B 130 also has an open port 138.

Switch C 140 has a source node 142 connected via port 2 and nodes 144 and 146 connected thereto via unlabeled ports.

Switch D 150 has a requestor node 152 connected via port 5 and nodes 154, 156, and 158 connected thereto via unlabeled ports.

Switch E 160 has nodes 162, 164, and 166 connected thereto via unlabeled ports.

Many vehicles offer a form of on-board diagnostics (OBD) for a vehicle's self-diagnostic and reporting capability. Modern OBD implementations use a standardized digital communications port to provide real-time data in addition to a standardized series of diagnostic trouble codes (DTCs), which allow a person to rapidly identify and remedy malfunctions within the vehicle. In some implementations described herein, vehicle 100 utilizes automotive diagnostic codes (ADC) or routine control codes (RCC) that indicate the system or area of the vehicle where there may be an issue that needs further investigation.

For example, the first character of an ADC may indicate the system or area of the vehicle where a problem is located. For example, “P” stands for powertrain, “C” for chassis, “B” for body, and “U” for network communication. The second character signifies whether the issue is generic (0) or manufacturer-specific (1).

Requestor node 152 may be an external automotive diagnostic tool that is physically connected to the in-vehicle network 110 of vehicle 100 via an available port of an available switch of the network. As depicted, port 5 of switch D 150 is available for an external device, such as an automotive diagnostic tool, may be connected to the in-vehicle network 110. Such a tool may be called a “tester.”

In some implementations described herein, after the requester node 152 connects to port 5 of switch D 150, the request sends a traffic-mirroring request to the facilitator node 132. The traffic-mirroring request may include an ADC code in question. That is, there may be an issue based on the ADC code. That code is associated with a node on the in-vehicle network. To better troubleshoot the issue, it would be helpful to example a log of the network traffic associated with issue that caused the ADC code. However, the tester does not know the network topology of the in-vehicle network 110 of this vehicle 100.

A network topology refers to the physical and logical layout of a network. It defines how different nodes and devices connect to one another to enable communication and data exchange. The topology depicts the arrangement of network elements like routers, switches, firewalls, end device endpoints, etc., and the interconnections between them. Unless the context indicates otherwise, the network topology herein refers to the data link (i.e., L2) layer.

With some of the implementations described herein, the tester (as requester node 152) supplies the subject ADC code via a traffic-mirroring request to the facilitator node 132. That ADC code is associated with the source node 142. For example, the ADC may have a “P,” which indicates that the powertrain may be involved. Thus, source node 142 may be the powertrain system of vehicle 100. Consequently, this ADC code is a source-node associated code.

While the tester (as requester node 152) does not know which system/node is at issue, the effect of the request to the facilitator node 132 is to request that the tester receive a copy (i.e., a mirror) of network traffic to and from the source node 142.

Ethernet traffic mirroring is a method of monitoring network traffic by forwarding copies of incoming and outgoing packets from one port (e.g., a mirroring source port) of a switch (source switch) to another port (mirroring destination port) of another switch (e.g., destination switch) where the packet copies can be studied. Herein, the network traffic of the port (Switch C: port 2) of the source node 142 is mirrored to the port (Switch D: port 5) of the requester node 152.

This enables network analysis and troubleshooting by allowing network traffic to be studied without interfering with the production network. A mirror destination port receives copies of traffic that passes through one or more switches and their interconnected ports along the traffic-mirroring path. This has a minimum effect on switching performance or network throughput in most cases since the mirroring is done via hardware on the switch and the mirrored traffic can be set to low priority.

The facilitator node 132 is an ECU that manages the network and knows its topology. Based on the source-node associated code, the facilitator node 132 identifies the source node (which, as depicted, that source node is 142) and determines which port and switch the source node is connected thereto. As depicted, the source port is 2 and the source switch is C 140.

The facilitator node 132 has a network topology matrix stored in an accessible memory. The network topology matrix specifies one or more ports of each switch that connects to at least one of the other multiple interconnected switches of the network topology. Each entry in the network topology matrix specifies which one or more ports of a switch are directly connected to which one or more ports of directly connected switches of the multiple interconnected switches of the network topology.

Based on FIG. 1, Table 1 below is an example of a network topology matrix:

TABLE 1

| | A | B | C | D | E |
|---|---|---|---|---|---|
| A | N/A | (7.7) | (1.3) | (6.3) | |
| | | | (3.4) | | |
| B | (7.7) | N/A | | | (2.6) |
| C | (3.1) | | N/A | | |
| | (4.3) | | | | |
| D | (3.6) | | | N/A | (8.8) |
| | | | | | (6.4) |
| E | | (6.2) | | (8.8) | N/A |
| | | | | (4.6) | |

The matrix of Table 1 shows the ports used to connect switches (A-E) to each other. A blank entry indicates that there is no direct connection between the switches of that entry. If there is a direct connection, the numbers indicate the ports of those switches that are interconnected.

The facilitator node 132 determines a traffic-mirroring network path between the source node and the requester node by using the network topology matrix. The facilitator node 132 may calculate an optimal network path between the source node and the requester node assign the calculated optimal network path to the traffic-mirroring network path.

The facilitator node 132 initiates mirroring of the network traffic of the source node 142 by sending traffic-mirroring instructions to the switches in the determined traffic-mirroring network path that instruct such switches to mirror network traffic of the source port to the request node 152.

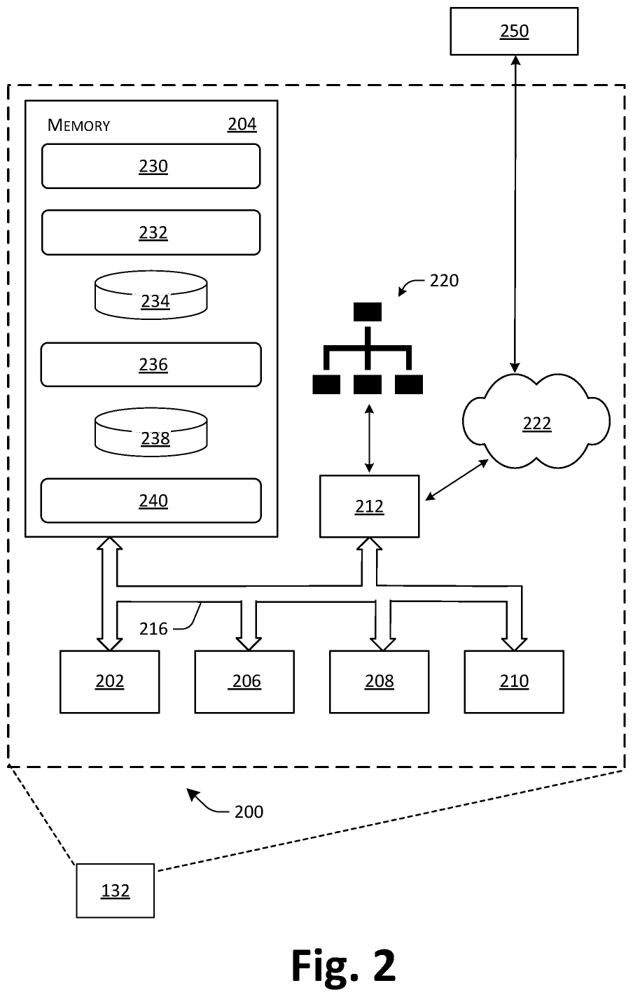

FIG. 2 illustrates an example of computer architecture for a computing system 200 capable of executing the technology described herein. The computer architecture in this figure illustrates a typical in-vehicle ECU or computer system. The facilitator node 132 may be implemented as the computing system 200. However, this system can be also a server computer, workstation, desktop computer, laptop, tablet, network appliance, e-reader, smartphone, embedded system, or another computing device. While shown as a single discrete device, the computing system 200 may be part of a distributed and interconnected set of components that accomplish the same functions.

The computing system 200 includes a processor 202 (e.g., central processor unit or “CPU”), system storage (e.g., memory) 204, input/output (I/O) devices 206-such as a display, a keyboard, a mouse, a microphone, a camera, and associated controllers, a secondary storage system 208 (e.g., a hard drive), and various other subsystems 210. In various embodiments, the computing system 200 also includes a communications (“comm”) port 212, operable to connect to an in-vehicle network 220 or external communications (“comm”) system 222. The preceding components may be interconnected via one or more buses 216, in-vehicle network 220, and/or comm system 222.

The comm system 222 enables external wireless communications with devices and networks external to the system, such as with an external communication network 250. The external wireless communication may include, for example, one or more of the following: satellite communications, WI-FI™, BLUETOOTH™, cellular communications, radio communications, and/or Internet communications.

System memory 204 may store data and machine-readable instructions (e.g., computer-readable instructions). Machine-readable instructions may configure the computing system 200. Machine-readable instructions may include one or more instruction modules. The instruction modules may include computer program modules. The instruction modules may include one or more of a request processor 230, an ADC lookup 232, an ADC database 234, a path determiner 236, a network topology matrix 238, a network instructor 240, and/or other instruction-based modules.

While the modules in the example depicted by this figure are implemented using machine-readable instructions, other similarly functioning modules may be implemented using little to no machine-readable instructions. Such modules are implemented via hardware (e.g., circuitry) and analog and/or digital signals. In other instances, such modules may be implemented via a combination of hardware and machine-implemented instructions.

The request processor 230 receives a traffic-mirroring request from the requester node 152. The traffic-mirroring request includes a code that is associated with the source node 142 in an automotive Ethernet network, such as the in-vehicle network 220, which has a network topology of multiple interconnected switches. The code is called a source-node associated code.

The source-node associated code may be, for example, an indicator of the source node, an indicator of the source port and source switch of the source node, an automotive diagnostic code that is indicative of the source node, and a combination thereof.

In one or more implementations, the requester node 152 connects to a requester port (e.g., port 5 as destination port) of a requester switch (e.g., switch D 150 as destination switch) of the multiple interconnected switches (e.g., Switches A-E) of the network topology and the request from the requester node is associated with an identification of the requester port and the requester switch (e.g., destination port and destination switch of the traffic mirroring).

Based on the ADC database 234, the ADC lookup 232 finds the source-node associated code in the database and finds the system or node associated with that code. More particularly, the ADC lookup 232 determines the source port and the source switch through which the source node directly links to the in-vehicle network.

In some implementations, the ADC lookup 232 determines the source port and the source switch by obtaining a table of node-associated codes; finding an entry in the table that matches the received code; extracting an identification of a switch and one of its ports from the entry; assigning the identified switch and port as the source port and the source switch through which the source node directly links to the in-vehicle network.

The path determiner 236 obtains a network topology matrix 238. The network topology matrix 238 specifies one or more ports of each switch that connects to at least one of the other multiple interconnected switches of the network topology. Each entry in the network topology matrix specifies which one or more ports of a switch are directly connected to which one or more ports of directly connected switches of the multiple interconnected switches of the network topology. Based on the obtained network topology matrix, the path determiner 236 determines a traffic-mirroring network path between the source node and the requester node.

The path determiner 236 calculates an optimal network path between the source node and the requester node and assigns the calculated optimal network path to the traffic-mirroring network path. In a network path, each of the switches are considered nodes of a graph and their interconnections, e.g., links are considered as distances between the nodes. In some implementations, the calculation of the optimal network path employs zero weighting (e.g., equal distance for all the links) to determine the shortest path. In other implementations, the calculation of the optimal network path employs weighting on those links to determine the shortest path. For example, the weighting can be assigned to each link based on the bandwidth utilization estimated on that link at system design time. In some implementations, the facilitator node tracks the functional traffic bandwidth utilization on each port and/or switch of the network topology at real time and the weighting on the links is dynamically calculated and updated based on the functional traffic bandwidth utilization on those links.

The network instructor 240 initiates mirroring of the network traffic of the source node by sending traffic-mirroring instructions to individual switches in the determined traffic- mirroring network path that instruct each switch to activate the self-port mirroring of the traffic from its own source port to its own destination port. Switches typically have self-port mirroring feature. With one or more implementations described herein, the technology achieves whole network-level traffic mirroring across multiple switches by instructing individual switches to turn on their associated self-port mirroring. To do this, there is a calculation of a best mirroring path from the source switch to the destination switch. Also, a determination is made for each switch on the path, what is its self-mirroring source port and destination port.

For example, the shortest path from a source switch to a destination switch may be C→A→D. If so, then this might be the specific best path: C(port2)→C(port3)→A(port1)→A(port6)→D(port3)→D(port5). This is based on the topology matrix. Based on this, the final mirroring configuration for each switch on the path may be C(port2→port3), A(port1→port6), D(port3→port5).

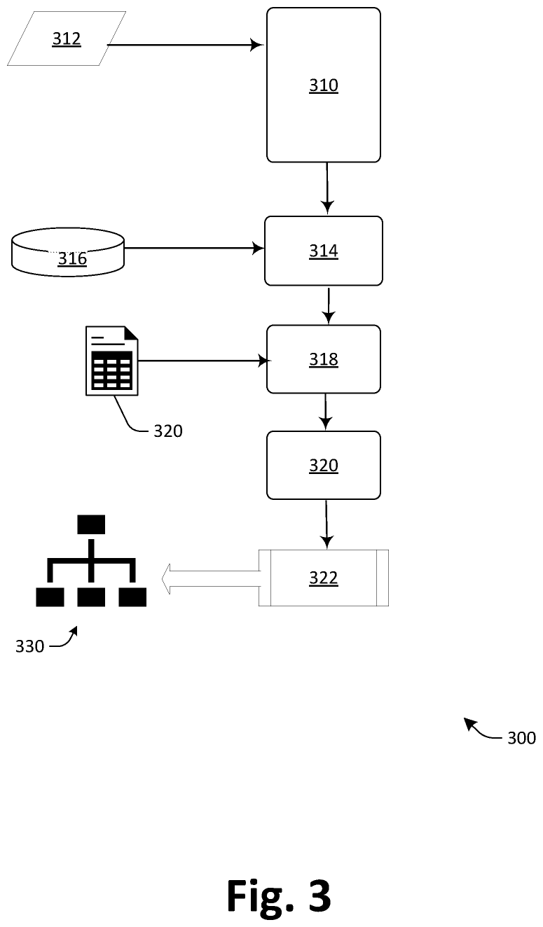

FIG. 3 is a flowchart that illustrates process 300 to perform an example method that facilitates dynamic traffic monitoring of automotive Ethernet traffic across a network topology. For ease of illustration, process 300 may be described as being performed by a system described herein. Such a system may be, for example, the facilitator node 132 or the computing system 200. Process 300 represents the dynamic traffic monitoring of automotive Ethernet traffic across a network topology.

At operation 310, the system receives a traffic-mirroring request 312 from a requester node (such as a tester at requester node 152). The traffic-mirroring request includes a code that is associated with a source node (such as the source node 142) in an automotive Ethernet network, such as the in-vehicle network 220, which has a network topology of multiple interconnected switches. The code is called a source-node associated code.

The source-node associated code may be, for example, an indicator of the source node, an indicator of the source port and source switch of the source node, an automotive diagnostic routine control code that is indicative of the source node, and a combination thereof.

In one or more implementations, the requester node 152 connects to a requester port (e.g., port 5) of a requester switch (e.g., switch D 150) of the multiple interconnected switches (e.g., Switches A-E) of the network topology and the request from the requester node is associated with an identification of the requester port (e.g., final destination port) and the requester switch (e.g., destination switch).

At operation 314, the system (e.g., the facilitator node 132) finds the source-node associated code in an ADC database 316. The system finds the node associated with that code. More particularly, the system determines the source port and the source switch through which the source node directly links to the in-vehicle network.

In some implementations, the facilitator node determines the source port and the source switch by obtaining a table of node-associated codes (such as the ADC database 316); finding an entry in the table that matches the received code; extracting an identification of a switch and one of its ports from the entry; assigning the identified switch and port as the source port and the source switch through which the source node directly links to the in-vehicle network.

At operation 318, the system (e.g., facilitator node 132) obtains a network topology matrix 320. The network topology matrix 320 specifies one or more ports of each switch that connect to at least one of the other multiple interconnected switches of the network topology. Each entry in the network topology matrix specifies which one or more ports of a switch are directly connected (e.g., directly linked) to which one or more ports of directly connected switches of the multiple interconnected switches of the network topology. Based on the obtained network topology matrix, the system determines a traffic-mirroring network path between the source node and the requester node.

Further at operation 318, the system calculates an optimal network path between the source node and the destination node and assigns the calculated optimal network path to the traffic-mirroring network path. In some instances, and/or more particularly, the system calculates an optimal network path between the source port of the source switch and the destination port of the destination switch and assigns the calculated optimal network path to the traffic-mirroring network path. In some implementations, the switches are considered nodes of a graph and their interconnections, e.g., links are considered as distances between the nodes. The calculation of the optimal network path employs zero weighting (e.g., equal distance for all the links) to determine the shortest path.

In other implementations, the calculation of the optimal network path employs weighting on those links to determine the shortest path. For example, the weighting can be assigned to each link based on the bandwidth utilization estimated on that link at system design time. In some implementations, the facilitator node tracks the functional traffic bandwidth utilization on each port and/or switch of the network topology at real time and the weighting on the links is dynamically calculated and updated based on the functional traffic bandwidth utilization on those links.

At operation 322, the system generates traffic-mirroring instructions for the switches in the determined traffic-mirroring network path that instruct such switches to mirror network traffic of the source port to the request node. In some instances, and/or more particularly, the system generates traffic-mirroring instructions for the switches in the determined traffic-mirroring network path that instruct such switches to activate self-port mirroring from their own source port to their own destination port.

As a consequence of operation 322, the system initiates mirroring of the network traffic of the source node by sending the generated traffic-mirroring instructions to an in-vehicle network 330. More particularly, the system sends the instructions to the switches of the determined traffic-mirroring network path that instructs such switches to activate the self-port mirroring.

In some implementations, the facilitator sends the self-port mirroring request with the associated information directly to each switch in the determined traffic mirroring path. In some implementations, the facilitator sends the self-port mirroring request with the associated information to multiple nodes (e.g., ECUs or a computer systems) in the network that are considered as the hosts for the switches in the determined traffic mirroring path. Subsequently, each host will forward the self-port mirroring request(s) to the switch(es) it controls.

In some implementations, the system may detect a change to the network topology and update the network topology matrix 320 accordingly. For example, the system may detect that a new node has been added to the network topology and, in response, the system may update the network topology matrix 320 to reflect the change in the topology.

The above description is intended to be illustrative and not restrictive. While the dimensions and types of materials described herein are intended to be illustrative, they are by no means limiting and are exemplary embodiments. In the following claims, use of the terms “first,” “second”, “top”, “bottom”, etc. are used merely as labels and are not intended to impose numerical or positional requirements on their objects. As used herein, an element or step recited in the singular and preceded by the word “a” or “an” should be understood as not excluding the plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51% to 99% out of a possible extent of 100%”, and do not necessarily mean “perfectly”, “completely”, “strictly”, “entirely” or “100%”. Additionally, the word “proximate” may be used herein to describe the location of an object or portion thereof concerning another object or portion thereof, and/or to describe the positional relationship of two objects or their respective portions thereof concerning each other, and may mean “near”, “adjacent”, “close to”, “close by”, “at” or the like. And the phrase “approximately equal to” as used herein may mean one or more of “exactly equal to”, “nearly equal to”, “equal to somewhere between 90% and 110% of” or the like.

This written description uses examples, including the best mode, to enable those skilled in the art to make and use devices, systems, and compositions of matter, and to perform methods, according to this disclosure. It is the following claims, including equivalents, which define the scope of the present disclosure.

What is claimed is:

1. A method that facilitates dynamic traffic monitoring of automotive Ethernet traffic across a network topology, the method comprising:
receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches;
based on the source-node associated code, determining a source port and a source switch through which the source node directly links to the automotive Ethernet network;
obtaining a network topology matrix, which specifies one or more ports of each switch that connects to at least one of the other multiple interconnected switches of the network topology;
based on the network topology matrix, determining a traffic-mirroring network path between the source node and the requester node; and
initiating mirroring of network traffic of the source node by sending, by the facilitator node via the automotive Ethernet network, traffic-mirroring instructions to switches in the determined traffic-mirroring network path that instruct such switches to mirror network traffic of the source port to the request node.

2. A method of claim 1, wherein the requester node connects to a requester port of a requester switch of the multiple interconnected switches of the network topology and the request from the requester node is associated with an identification of the requester port and the requester switch.

3. A method of claim 1, wherein the source-node associated code that is selected from a group consisting of an indicator of the source node, an indicator of the source port and source switch of the source node, an automotive diagnostic code that is indicative of the source node, and a combination thereof.

4. A method of claim 1, wherein the determination of the source port and source switch includes:
obtaining a table of node-associated codes;
finding an entry in the table that matches the received code;
extracting an identification of a switch and one of its ports from the entry; and
assigning the identified switch and port as the source port and the source switch through which the source node directly links to the automotive Ethernet network.

5. A method of claim 1, wherein each entry in the network topology matrix specifies which one or more ports of a switch are directly connected to which one or more ports of directly connected switches of the multiple interconnected switches of the network topology.

6. A method of claim 1 further comprising:
detecting, by the facilitator node, a change to the network topology; and
updating the network topology matrix accordingly.

7. A method of claim 1, wherein the determining of the traffic-mirroring network path includes:
calculating an optimal network path between the source node and the requester node; and
assigning the calculated optimal network path to the traffic-mirroring network path.

8. A method of claim 7, wherein the calculation of the optimal network path employs zero weighting to determine a shortest path.

9. A method of claim 7, wherein the calculation of the optimal network path employs weighting to determine a shortest path.

10. A method of claim 9, wherein the weighting is based upon a determination of functional traffic on each port and/or switch in a network path.

11. A method of claim 10, wherein the facilitator node tracks the functional traffic on each port and/or switch of the network topology.

12. A method of claim 1, wherein the traffic-mirroring instructions directly command the switches in the determined traffic-mirroring network path to mirror network traffic of the source port to the request node.

13. A method of claim 1, wherein the traffic-mirroring instructions requests that the switches in the determined traffic-mirroring network path cooperate in mirroring network traffic of the source port to the request node.

14. A vehicle comprising one or more processors and a non-transitory machine-readable storage medium encoded with instructions executable by one or more processors that, when executed, direct one or more processors to perform operations that facilitate dynamic traffic monitoring of automotive Ethernet traffic across a network topology, the operations comprising:
receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches;
based on the source-node associated code, determining a source port and a source switch through which the source node directly links to the automotive Ethernet network;
obtaining a network topology matrix, wherein each entry in the network topology matrix specifies which one or more ports of a switch are directly connected to which one or more ports of directly connected switches of the multiple interconnected switches of the network topology;
based on the network topology matrix, determining a traffic-mirroring network path between the source node and the requester node, wherein the determining of the traffic-mirroring network path includes calculating an optimal network path between the source node and the requester node; and
assigning the calculated optimal network path to the traffic-mirroring network path; and
initiating mirroring of network traffic of the source node by sending, by the facilitator node via the automotive Ethernet network, traffic-mirroring instructions to switches in the determined traffic-mirroring network path that instruct such switches to mirror network traffic of the source port to the request node.

15. A vehicle of claim 14, wherein the source-node associated code that is selected from a group consisting of an indicator of the source node, an indicator of the source port and source switch of the source node, an automotive diagnostic code that is indicative of the source node, and a combination thereof.

16. A vehicle of claim 14, wherein the determination of the source port and source switch includes:
obtaining a table of node-associated codes;
finding an entry in the table that matches the received code;
extracting an identification of a switch and one of its ports from the entry; and
assigning the identified switch and port as the source port and the source switch through which the source node directly links to the automotive Ethernet network.

17. A vehicle of claim 14, wherein the calculation of the optimal network path employs weighting to determine a shortest path and the weighting is based upon a determination of functional traffic on each port and/or switch in a network path.

18. A non-transitory machine-readable storage medium encoded with instructions executable by one or more processors that, when executed, direct one or more processors to perform operations that facilitates dynamic traffic monitoring of automotive Ethernet traffic across a network topology, the operations comprising:
receiving, by a facilitator node via an automotive Ethernet network, a traffic-mirroring request from a requester node, wherein the traffic-mirroring request includes a code that is associated with a source node in the automotive Ethernet network, which has a network topology of multiple interconnected switches;
based on the source-node associated code, determining a source port and a source switch through which the source node directly links to the automotive Ethernet network;
obtaining a network topology matrix, wherein each entry in the network topology matrix specifies which one or more ports of a switch are directly connected to which one or more ports of directly connected switches of the multiple interconnected switches of the network topology;
based on the network topology matrix, determining a traffic-mirroring network path between the source node and the requester node, wherein the determining of the traffic-mirroring network path includes calculating an optimal network path between the source node and the requester node; and
assigning the calculated optimal network path to the traffic-mirroring network path; and
initiating mirroring of network traffic of the source node by sending, by the facilitator node via the automotive Ethernet network, traffic-mirroring instructions to switches in the determined traffic-mirroring network path that instruct such switches to mirror network traffic of the source port to the request node.

19. A non-transitory machine-readable storage medium of claim 18, wherein the source-node associated code that is selected from a group consisting of an indicator of the source node, an indicator of the source port and source switch of the source node, an automotive diagnostic code that is indicative of the source node, and a combination thereof.

20. A non-transitory machine-readable storage medium of claim 18, wherein the calculation of the optimal network path employs weighting to determine a shortest path and the weighting is based upon a determination of functional traffic on each port and/or switch in a network path.
